(19) United States
(12) Patent Application Publication
(10) Pub. No.: US 2009/0024786 A1
(43) Pub. Date: Jan. 22, 2009

(54) External storage device

(76) Inventors: Cheng-Sheng Chan, Taipei City (TW); Chih-Chin Yang, Taipei City (TW); Chia-Chang Lee, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/875,964

(22) Filed: Oct. 22, 2007

(30) Foreign Application Priority Data
Jul. 16, 2007 (TW) 096125852

(51) Int. Cl. G06F 12/02

(52) U.S. Cl. 711/103; 711/E12.008

(57) ABSTRACT

An external storage device includes a hard-drive, a flash memory, and a memory arrangement unit. The memory arrangement determines if the tag of the data accessed by a computer stored in the tag list of the memory arrangement unit and controls the hard-drive and the flash memory according to the result of the determination.

### BACKGROUND OF THE INVENTION

1. Field of the Invention

The present invention provides a storage device, and more particularly, an external storage device.

2. Description of the Prior Art

Please refer to FIG. 1. FIG. 1 is a diagram illustrating a conventional external storage device 102. The external storage device 102 can be a Serial Advanced Technology Attachment (SATA) hard-drive, and coupled to a computer through an External SATA (eSATA) interface. In this way, the computer 101 transmits data to the external storage device 102 for storing data in the external storage device 102 or reads data from the external storage device 102 through the eSATA interface.

The drawback of the conventional external storage device 102 is the reading speed of the hard-drive being too slow. Consequently, if the computer 101 stores data which is frequently used in the conventional external storage device 102, when the computer 101 reads that data stored in the hard-drive, the computer has to wait, which is time-wasting. For example, the OS Window Vista can store programs for initiation in external devices. If the programs for initiation are stored in the external storage device 102, the time consumed by the initiation of the OS is too long due to the slowness of the hard-drive, causing inconvenience.

### SUMMARY OF THE INVENTION

The present invention provides an external storage device. The external storage device comprises a hard-drive for accessing data; a flash memory for accessing data; a memory arrangement unit for reading a tag of data accessed by a computer, determining if the tag is in a tag list of the memory arrangement unit, and accordingly controlling the hard-drive or the flash memory to access data with the computer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional external storage device.

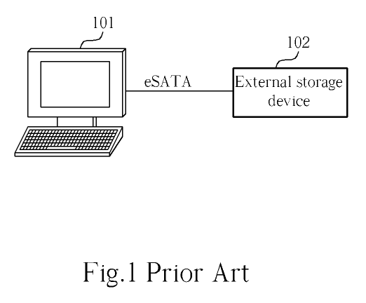

FIG. 2 is a diagram illustrating the external storage device of the present invention.

FIG. 3 is a flowchart illustrating the method of the external storage device of the present invention.

### DETAILED DESCRIPTION

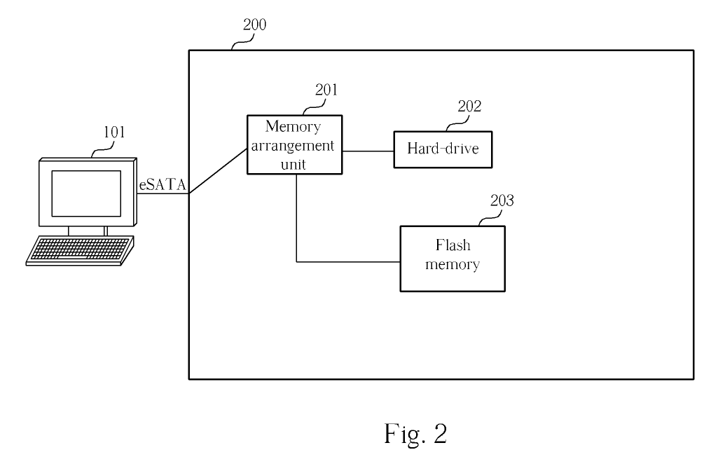

Please refer to FIG. 2. FIG. 2 is a diagram illustrating the external storage device 200 of the present invention. As shown in FIG. 2, the external storage device 200 comprises a memory arrangement unit 201, a hard-drive 202, and a flash memory. The memory arrangement unit 201 is coupled to the computer through an eSATA interface. The memory arrangement unit 201 is also coupled to the hard-drive 202 and the flash memory 203. Additionally, the hard-drive 202 and the flash memory 203 are both detachable for convenience.

The flash memory 203 has faster accessing speed than the hard-drive 202 does. Therefore, the initiation time of the computer 101 can be shortened by utilizing the flash memory 203 for accessing initiation programs. However, the memory size of the flash memory 203 is much less than that of the hard-drive 202. Thus, the memory arrangement unit 201 has to efficiently distribute the locations of data to be stored. That is, the data frequently used is stored in the flash memory 203, and the data rarely used is stored in the hard-drive 202. The spirit of the present invention is: when the computer 101 stores data in the external storage device 200, the flash memory 203 is provided to accelerate the initiation of the computer 101.

The memory arrangement unit 201 comprises a tag list for indexing the priority of the data. For example, if the data A is frequently accessed, the tag of the data A has higher priority in the tag list. On the other hand, if the data A is rarely accessed, the tag of the data A has lower priority in the tag list, or the tag of the data A is not in the tag list. The present invention uses such manner to control the priority of the data.

In this way, the initiation time of the computer 101 can be shortened by utilizing the external storage device 200. After the initiation of the computer 101, the external storage device 200 can also provide data storage to the computer 101, increasing the convenience.

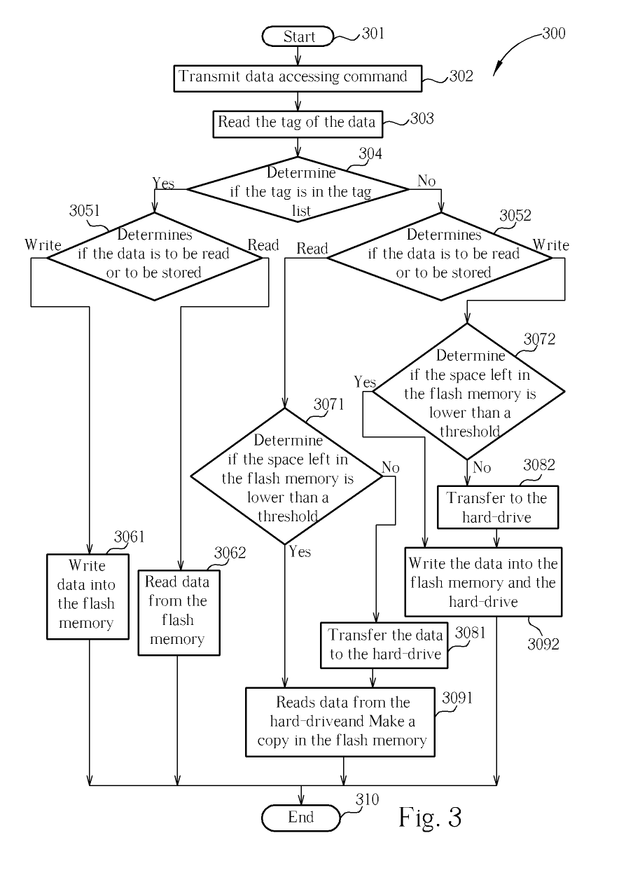

Please refer to FIG. 3. FIG. 3 is a flowchart illustrating the method 300 of the external storage device of the present invention. The steps are described as follows:

Step 301: Start;

Step 302: The computer 101 transmits a data accessing command;

Step 303: The memory arrangement unit 201 reads the tag of the data to be accessed;

Step 304: The memory arrangement unit 201 determines if the tag is in the tag list of the memory arrangement unit; if yes, go to step 3051; if no, go to step 3052;

Step 3051: The memory arrangement unit 201 determines if the data is to be read or to be stored; if the data is to be read, go to step 3061; if the data is to be stored, go to step 3062;

Step 3052: The memory arrangement unit 201 determines if the data is to be read or to be stored; if the data is to be read, go to step 3071; if the data is to be stored, go to step 3072;

Step 3061: The memory arrangement unit 201 writes data into the flash memory 203, go to step 310;

Step 3062: The memory arrangement unit 201 reads data from the flash memory 203, go to step 310;

Step 3071: The memory arrangement unit 201 determines if the space left in the flash memory 203 is lower than a threshold; if yes, go to step 3091; if not, go to step 3081;

Step 3072: The memory arrangement unit 201 determines if the space left in the flash memory 203 is lower than a threshold; if yes, go to step 3092; if not, go to step 3082;

Step 3081: The memory arrangement unit 201 transfers the data, having lower priority in the tag list and stored in the flash memory 203, to the hard-drive 202;

Step 3082: The memory arrangement unit 201 transfers the data, having lower priority in the tag list and stored in the flash memory 203, to the hard-drive 202;

Step 3091: The memory arrangement unit 201 reads data from the hard-drive 202 and makes a copy in the flash memory 203, go to step 310;

Step 3092: The memory arrangement unit 201 writes the data into the flash memory 203 and the hard-drive 202, go to step 310;

Step 310: End.

The hard-drive 202 and the flash memory 203 of the external storage device 200 of the present invention are detachable for providing users easier ways to change the storage components.

Additionally, the hard-drive 202 of the present invention can be Serial Advanced Technology Attachment (SATA) or Parallel Advanced Technology Attachment (PATA) interface.

Those skilled in the art will readily observe that numerous modifications and alterations of the device and method may be made while retaining the teachings of the invention.

What is claimed is:

1. An external storage device comprising:
a hard-drive for accessing data;
a flash memory for accessing data;
a memory arrangement unit for reading a tag of data accessed by a computer, determining if the tag is in a tag list of the memory arrangement unit, and accordingly controlling the hard-drive or the flash memory to access data with the computer.

2. The external storage device of claim 1, wherein when the tag is in the tag list of the memory arrangement unit, the memory arrangement unit controls the flash memory to access data with the computer.

3. The external storage device of claim 1, wherein when the tag is not in the tag list of the memory arrangement unit, the memory arrangement unit controls the hard drive to access data with the computer.

4. The external storage device of claim 1, wherein an interface between the arrangement unit and the computer is Serial Advanced Technology Attachment (SATA) interface.

5. The external storage device of claim 1, wherein an interface of the hard drive is SATA interface.

6. The external storage device of claim 1, wherein an interface of the hard drive is Parallel Advanced Technology Attachment (PATA) interface.

7. The external storage device of claim 1, wherein the hard drive is detachable.

8. The external storage device of claim 1, wherein the flash memory is detachable.
